(19) United States
(12) Patent Application Publication
(10) Pub. No.: US 2016/0295636 A1
(43) Pub. Date: Oct. 6, 2016

(54) USER EQUIPMENT BASED CONNECTED DISCONTINUOUS RECEPTION INTER RADIO ACCESS TECHNOLOGY MEASUREMENT

(71) Applicant: QUALCOMM Incorporated, San Diego, CA (US)

(72) Inventors: Ming YANG, San Diego, CA (US); Tom CHIN, San Diego, CA (US)

(21) Appl. No.: 14/813,108

(22) Filed: Jul. 29, 2015

Related U.S. Application Data
(60) Provisional application No. 62/141,757, filed on Apr. 1, 2015.

(51) Int. Cl. H04W 76/04; H04W 24/10; H04L 5/00; H04W 52/02; H04B 7/04

(52) U.S. Cl. CPC H04W 76/048; H04W 52/0264; H04B 7/0413; H04L 5/001; H04W 24/10

(57) ABSTRACT

A user equipment (UE) improves measurement procedures, such as signal quality measurements and base station identity code (BSIC) procedures. In one instance, the UE determines signal qualities of a serving cell and neighbor cells of a serving RAT (radio access technology). The UE the adjusts a C-DRX off duration connected discontinuous reception off duration) on a component carrier to perform measurements of a non-serving RAT during the C-DRX off duration based on the determined signal qualities of the serving RAT.

### CROSS-REFERENCE TO RELATED APPLICATION

This application claims the benefit under 35 U.S.C. §119(e) to U.S. Provisional Patent Application No. 62/141,757, entitled “USER EQUIPMENT BASED CONNECTED DISCONTINUOUS RECEPTION INTER RADIO ACCESS TECHNOLOGY MEASUREMENT,” filed on Apr. 1, 2015, in the names of YANG, et al., the disclosure of which is expressly incorporated by reference herein in its entirety.

### BACKGROUND

1. Field

Aspects of the present disclosure relate generally to wireless communication systems, and more particularly, to performing measurements during a discontinuous reception (DRX) cycle.

2. Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but also to advance and enhance the user experience with mobile communications.

### SUMMARY

According to one aspect of the present disclosure, a method of wireless communication includes determining signal qualities of a serving cell and neighbor cells of a serving RAT (radio access technology). The method also includes adjusting a C-DRX off duration (connected discontinuous reception off duration) on a component carrier to perform measurements of a non-serving RAT during the C-DRX off duration based on the determined signal qualities of the serving RAT.

According to another aspect of the present disclosure, an apparatus for wireless communication includes means for determining signal qualities of a serving cell and neighbor cells of a serving RAT (radio access technology). The apparatus may also include means for adjusting a C-DRX off duration (connected discontinuous reception off duration) on a component carrier to perform measurements of a non-serving RAT during the C-DRX off duration based on the determined signal qualities of the serving RAT.

Another aspect discloses an apparatus for wireless communication and includes a memory and at least one processor coupled to the memory. The processor(s) is configured to determine signal qualities of a serving cell and neighbor cells of a serving RAT (radio access technology). The processor(s) is also configured to adjust a C-DRX off duration (connected discontinuous reception off duration) on a component carrier to perform measurements of a non-serving RAT during the C-DRX off duration based on the determined signal qualities of the serving RAT.

Yet another aspect discloses a computer program product for wireless communications in a wireless network having a non-transitory computer-readable medium. The computer-readable medium has non-transitory program code recorded thereon which, when executed by the processor(s), causes the processor(s) to determine signal qualities of a serving cell and neighbor cells of a serving RAT (radio access technology). The program code further causes the processor(s) to adjust a C-DRX off duration (connected discontinuous reception off duration) on a component carrier to perform measurements of a non-serving RAT during the C-DRX off duration based on the determined signal qualities of the serving RAT.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a diagram illustrating an example of a network architecture.

FIG. 2 is a diagram illustrating an example of a downlink frame structure in LTE.

FIG. 3 is a diagram illustrating an example of an uplink frame structure in LTE.

FIG. 4 is a block diagram illustrating an example of a global system for mobile communications (GSM) frame structure.

FIG. 5 is a block diagram conceptually illustrating an example of a base station in communication with a user equipment (UE) in a telecommunications system.

FIG. 6 is a block diagram illustrating the timing of channel carriers according to aspects of the present disclosure.

FIG. 7 is a diagram illustrating network coverage areas according to aspects of the present disclosure.

FIG. 8 is a flow diagram illustrating an example decision process for search and measurement of neighbor cells.

FIG. 9 illustrates an exemplary discontinuous reception communication cycle.

FIG. 10 illustrates exemplary component carriers configured for carrier aggregation during a discontinuous reception (DRX) cycle.

FIG. 11 is a flow diagram illustrating a method for performing measurements during a discontinuous reception cycle according to one aspect of the present disclosure.

FIG. 12 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

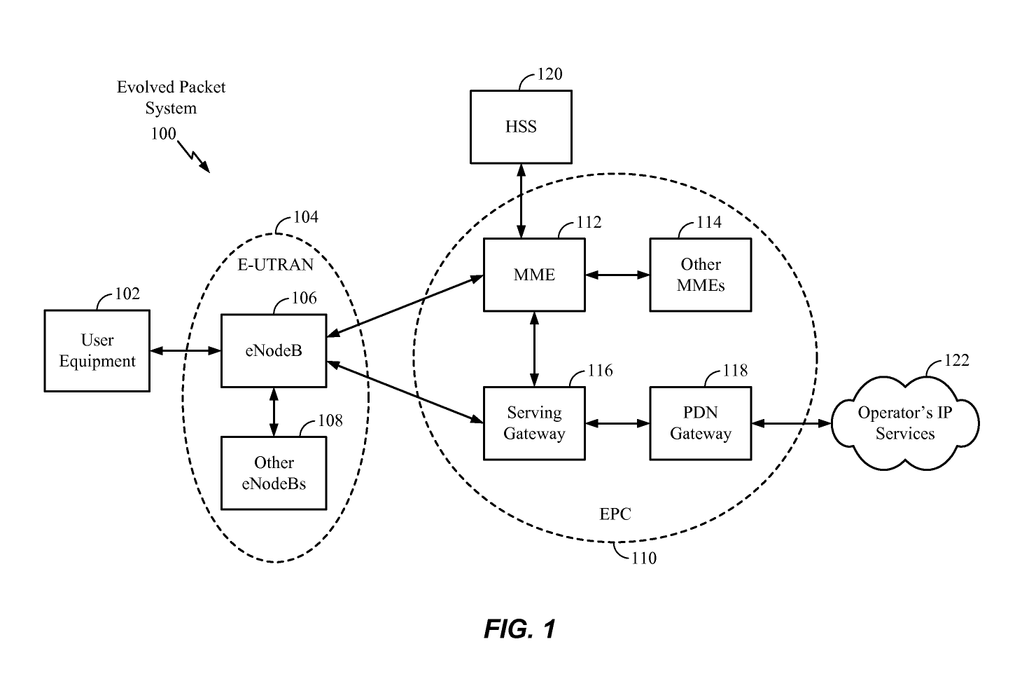

FIG. 1 is a diagram illustrating a network architecture 100 of a long-term evolution (LTE) network. The LTE network architecture 100 may be referred to as an evolved packet system (EPS) 100. The EPS 100 may include one or more user equipment (UE) 102, an evolved UMTS terrestrial radio access network (E-UTRAN) 104, an evolved packet core (EPC) 110, a home subscriber server (HSS) 120, and an operator's IP services 122. The EPS can interconnect with other access networks, but for simplicity those entities/interfaces are not shown. As shown, the EPS 100 provides packet-switched services, however, as those skilled in the art will readily appreciate, the various concepts presented throughout this disclosure may be extended to networks providing circuit-switched services.

The E-UTRAN 104 includes an evolved NodeB (eNodeB) 106 and other eNodeBs 108. The eNodeB 106 provides user and control plane protocol terminations toward the UE 102. The eNodeB 106 may be connected to the other eNodeBs 108 via a backhaul (e.g., an X2 interface). The eNodeB 106 may also be referred to as a base station, a base transceiver station, a radio base station, a radio transceiver, a transceiver function, a basic service set (BSS), an extended service set (ESS), or some other suitable terminology. The eNodeB 106 provides an access point to the EPC 110 for a UE 102. Examples of UEs 102 include a cellular phone, a smart phone, a session initiation protocol (SIP) phone, a laptop, a notebook, a netbook, a smartbook, a personal digital assistant (PDA), a satellite radio, a global positioning system, a multimedia device, a video device, a digital audio player (e.g., MP3 player), a camera, a game console, or any other similar functioning device. The UE 102 may also be referred to by those skilled in the art as a mobile station or apparatus, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNodeB 106 is connected to the EPC 110 via, e.g., an S1 interface. The EPC 110 includes a mobility management entity (MME) 112, other MMEs 114, a serving gateway 116, and a packet data network (PDN) gateway 118. The MME 112 is the control node that processes the signaling between the UE 102 and the EPC 110. Generally, the MME 112 provides bearer and connection management. All user IP packets are transferred through the serving gateway 116, which itself is connected to the PDN gateway 118. The PDN gateway 118 provides UE IP address allocation as well as other functions. The PDN gateway 118 is connected to the operator's IP services 122. The operator's IP services 122 may include the Internet, the Intranet, an IP multimedia subsystem (IMS), and a PS streaming service (PSS).

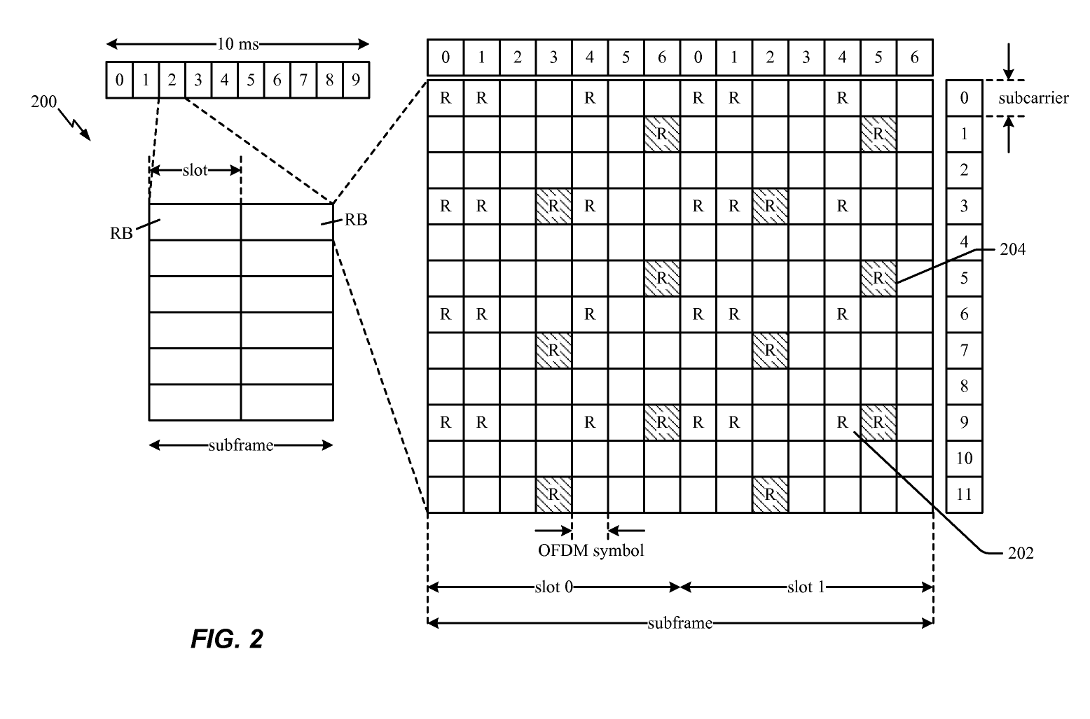

FIG. 2 is a diagram 200 illustrating an example of a downlink frame structure in LTE. A frame (10 ms) may be divided into 10 equally sized sub-frames. Each sub-frame may include two consecutive time slots. A resource grid may be used to represent two time slots, each time slot including a resource block. The resource grid is divided into multiple resource elements. In LTE, a resource block contains 12 consecutive subcarriers in the frequency domain and, for a normal cyclic prefix in each OFDM symbol, 7 consecutive OFDM symbols in the time domain, or 84 resource elements. For an extended cyclic prefix, a resource block contains 6 consecutive OFDM symbols in the time domain and has 72 resource elements. Some of the resource elements, as indicated as R 202, 204, include downlink reference signals (DL-RS). The DL-RS include Cell-specific RS (CRS) (also sometimes called common RS) 202 and UE-specific RS (UE-RS) 204. UE-RS 204 are transmitted only on the resource blocks upon which the corresponding physical downlink shared channel (PDSCH) is mapped. The number of bits carried by each resource element depends on the modulation scheme. Thus, the more resource blocks that a UE receives and the higher the modulation scheme, the higher the data rate for the UE.

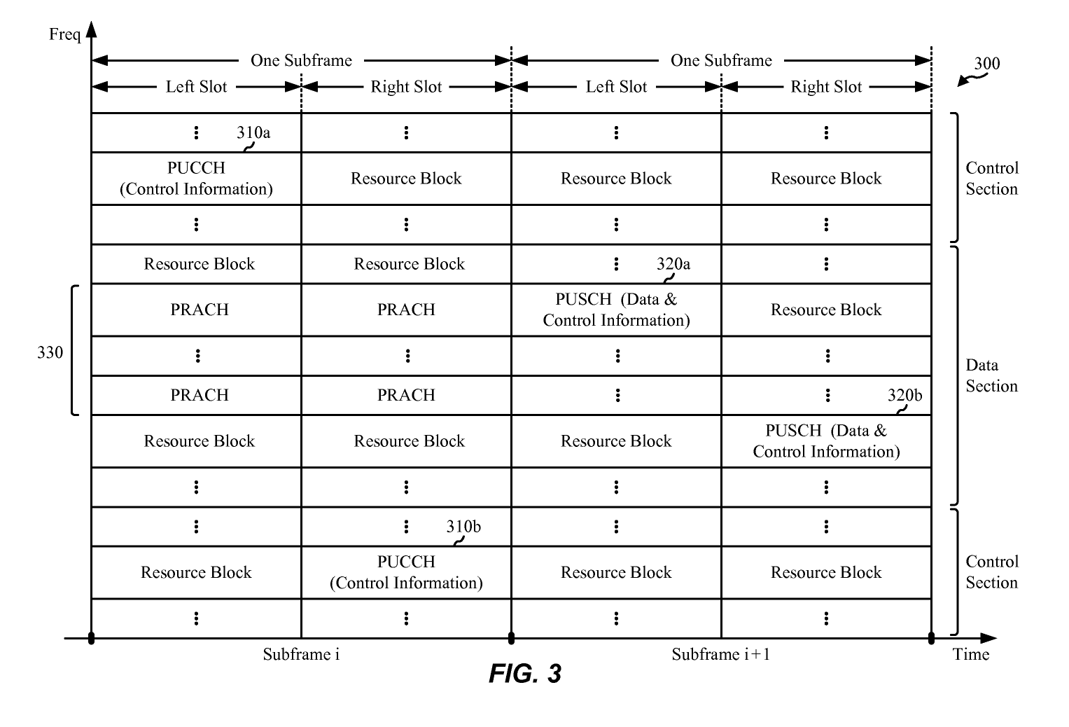

FIG. 3 is a diagram 300 illustrating an example of an uplink frame structure in LTE. The available resource blocks for the uplink may be partitioned into a data section and a control section. The control section may be formed at the two edges of the system bandwidth and may have a configurable size. The resource blocks in the control section may be assigned to UEs for transmission of control information. The data section may include all resource blocks not included in the control section. The uplink frame structure results in the data section including contiguous subcarriers, which may allow a single UE to be assigned all of the contiguous subcarriers in the data section.

A UE may be assigned resource blocks 310a, 310b in the control section to transmit control information to an eNodeB. The UE may also be assigned resource blocks 320a, 320b in the data section to transmit data to the eNodeB. The UE may transmit control information in a physical uplink control channel (PUCCH) on the assigned resource blocks in the control section. The UE may transmit only data or both data and control information in a physical uplink shared channel (PUSCH) on the assigned resource blocks in the data section. An uplink transmission may span both slots of a subframe and may hop across frequency.

A set of resource blocks may be used to perform initial system access and achieve uplink synchronization in a physical random access channel (PRACH) 330. The PRACH 330 carries a random sequence and cannot carry any uplink data/signaling. Each random access preamble occupies a bandwidth corresponding to six consecutive resource blocks. The starting frequency is specified by the network. That is, the transmission of the random access preamble is restricted to certain time and frequency resources. There is no frequency hopping for the PRACH. The PRACH attempt is carried in a single subframe (1 ms) or in a sequence of few contiguous subframes and a UE can make only a single PRACH attempt per frame (10 ms).

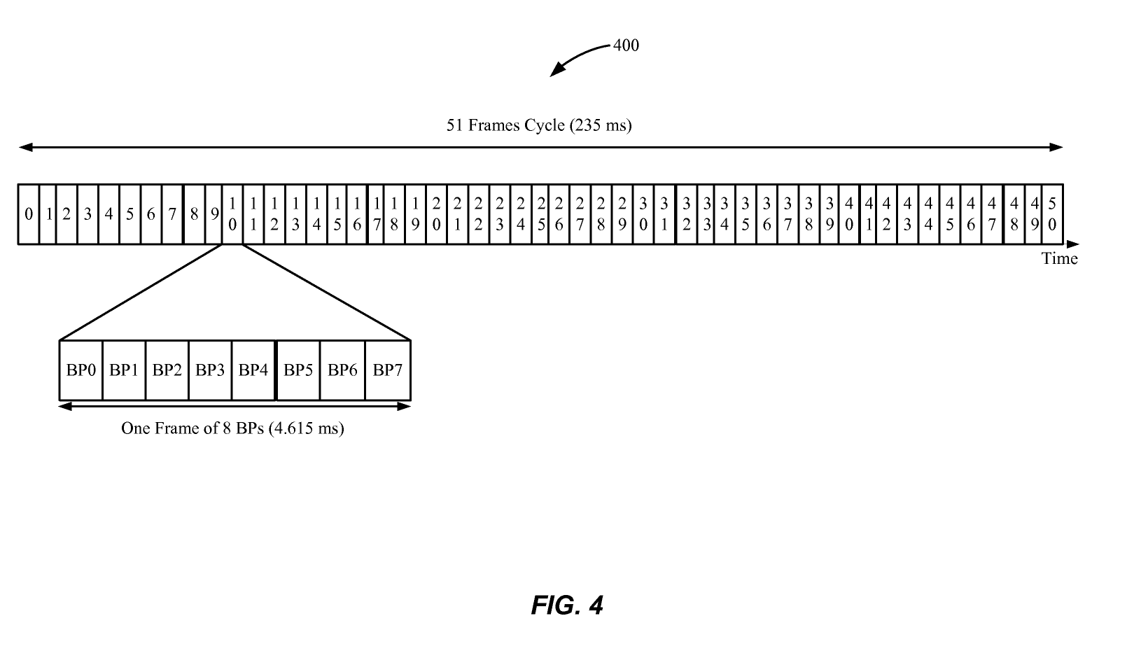

FIG. 4 is a block diagram illustrating an example of a GSM frame structure 400. The GSM frame structure 400 includes fifty-one frame cycles for a total duration of 235 ms. Each frame of the GSM frame structure 400 may have a frame length of 4.615 ms and may include eight burst periods, BP0-BP7.

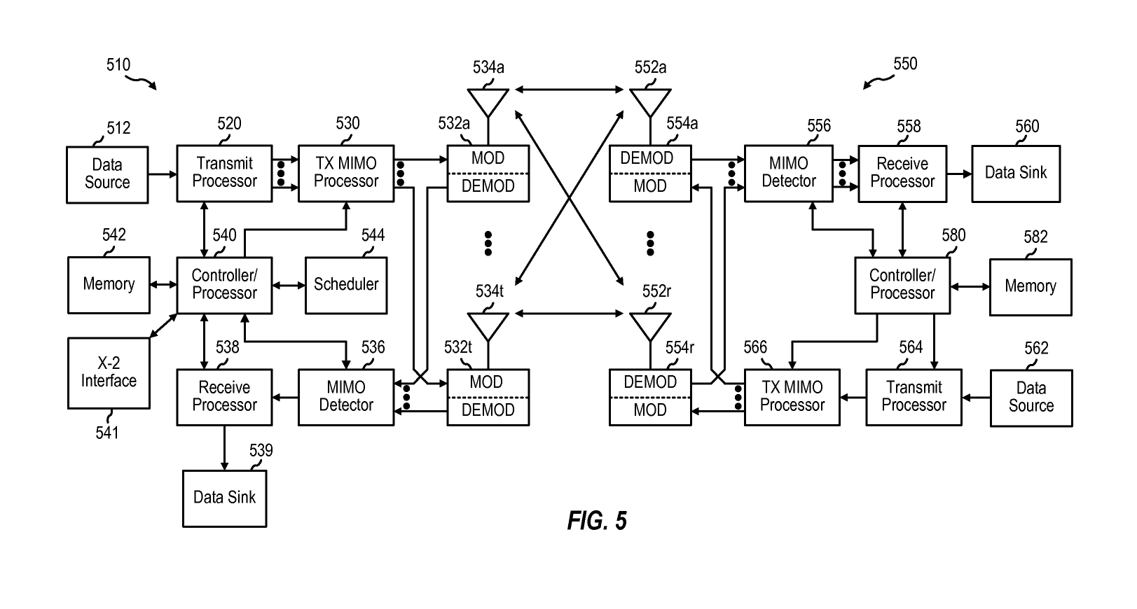

FIG. 5 is a block diagram of a base station (e.g., eNodeB or nodeB) 510 in communication with a UE 550 in an access network. In the downlink, upper layer packets from the core network are provided to a controller/processor 580. The base station 510 may be equipped with antennas 534a through 534t, and the UE 550 may be equipped with antennas 552a through 552r.

At the base station 510, a transmit processor 520 may receive data from a data source 512 and control information from a controller/processor 540. The control information may be for the PBCH, PCFICH, PHICH, PDCCH, etc. The data may be for the PDSCH, etc. The processor 520 may process (e.g., encode and symbol map) the data and control information to obtain data symbols and control symbols, respectively. The processor 520 may also generate reference symbols, e.g., for the PSS, SSS, and cell-specific reference signal. A transmit (TX) multiple-input multiple-output (MIMO) processor 530 may perform spatial processing (e.g., precoding) on the data symbols, the control symbols, and/or the reference symbols, if applicable, and may provide output symbol streams to the modulators (MODs) 532a through 532t. Each modulator 532 may process a respective output symbol stream (e.g., for OFDM, etc.) to obtain an output sample stream. Each modulator 532 may further process (e.g., convert to analog, amplify, filter, and upconvert) the output sample stream to obtain a downlink signal. Downlink signals from modulators 532a through 532t may be transmitted via the antennas 534a through 534t, respectively.

At the UE 550, the antennas 552a through 552r may receive the downlink signals from the base station 510 and may provide received signals to the demodulators (DEMODs) 554a through 554r, respectively. Each demodulator 554 may condition (e.g., filter, amplify, downconvert, and digitize) a respective received signal to obtain input samples. Each demodulator 554 may further process the input samples (e.g., for OFDM, etc.) to obtain received symbols. A MIMO detector 556 may obtain received symbols from all the demodulators 554a through 554r, perform MIMO detection on the received symbols if applicable, and provide detected symbols. A receive processor 558 may process (e.g., demodulate, deinterleave, and decode) the detected symbols, provide decoded data for the UE 550 to a data sink 560, and provide decoded control information to a controller/processor 580.

On the uplink, at the UE 550, a transmit processor 564 may receive and process data (e.g., for the PUSCH) from a data source 562 and control information (e.g., for the PUCCH) from the controller/processor 580. The processor 564 may also generate reference symbols for a reference signal. The symbols from the transmit processor 564 may be precoded by a TX MIMO processor 566 if applicable, further processed by the modulators 554a through 554r (e.g., for SC-FDM, etc.), and transmitted to the base station 510. At the base station 510, the uplink signals from the UE 550 may be received by the antennas 534, processed by the demodulators 532, detected by a MIMO detector 536 if applicable, and further processed by a receive processor 538 to obtain decoded data and control information sent by the UE 550. The processor 538 may provide the decoded data to a data sink 539 and the decoded control information to the controller/processor 540. The base station 510 can send messages to other base stations, for example, over an X2 interface 541.

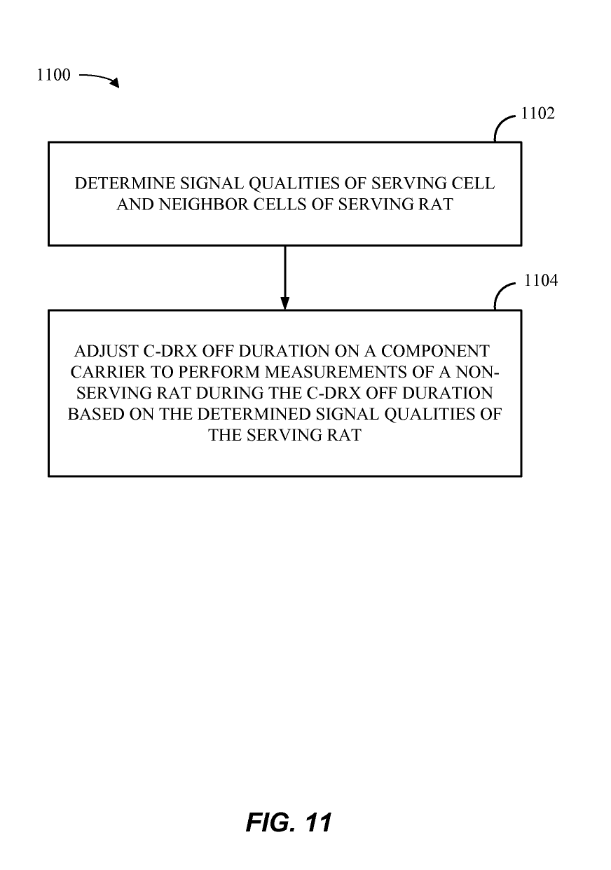

The controllers/processors 540 and 580 may direct the operation at the base station 510 and the UE 550, respectively. The processor 540/580 and/or other processors and modules at the base station 510/ UE 550 may perform or direct the execution of the functional blocks illustrated in FIG. 11, and/or other processes for the techniques described herein. For example, the memory 582 of the UE 550 may store a wireless communication module 591 which, when executed by the controller/processor 580, configures the UE 550 to perform measurements during a connected discontinuous reception cycle and to adjust a duration for performing the measurements. The memories 542 and 582 may store data and program codes for the base station 510 and the UE 550, respectively. A scheduler 544 may schedule UEs for data transmission on the downlink and/or uplink.

In the uplink, the controller/processor 580 provides demultiplexing between transport and logical channels, packet reassembly, deciphering, header decompression, control signal processing to recover upper layer packets from the UE 550. Upper layer packets from the controller/processor 580 may be provided to the core network. The controller/processor 580 is also responsible for error detection using an ACK and/or NACK protocol to support HARQ operations.

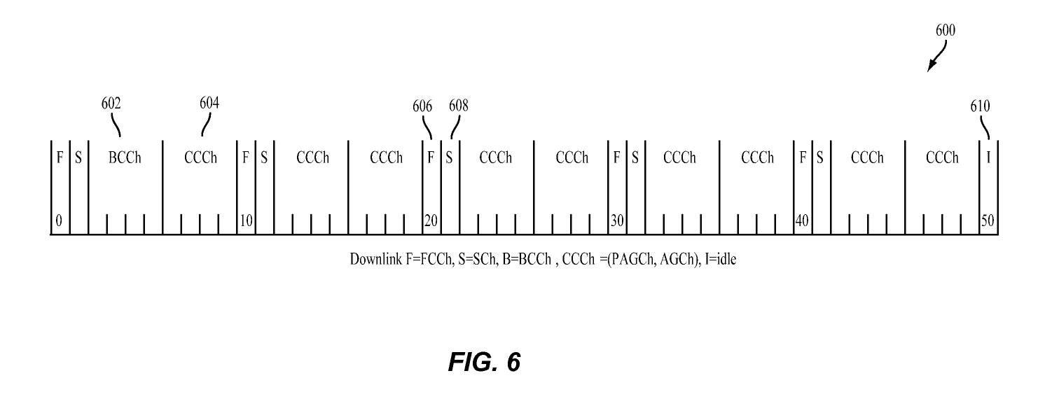

FIG. 6 is a block diagram 600 illustrating the timing of channels according to aspects of the present disclosure. The block diagram 600 shows a broadcast control channel (BCCH) 602, a common control channel (CCCH) 604, a frequency correction channel (FCCH) 606, a synchronization channel (SCH) 608 and an idle time slot 610. The numbers at the bottom of the block diagram 600 indicate various moments in time. In one configuration, the numbers at the bottom of the block diagram 600 are in seconds. In one configuration, each block of an FCCH 606 may include eight time slots, with only the first timeslot (or TS0) used for FCCH tone detection.

The timing of the channels shown in the block diagram 600 may be determined in a base station identity code (BSIC) identification procedure. The BSIC identification procedure may include detection of the FCCH carrier 606, based on a fixed bit sequence that is carried on the FCCH 606. FCCH tone detection is performed to find the relative timing between multiple RATs. The FCCH tone detection may be based on the SCH 608 being either a first number of frames or a second number of frames later in time than the FCCH 606. The first number of frames may be equal to 11+n·10 frames and the second number of frames may be equal to 12+n·10 frames. The dot operator represents multiplication and n can be any positive number. These equations are used to schedule idle time slots to decode the SCH. The first number of frames and the second number of frames may be used to schedule idle time slots in order to decode the SCH 608, in case the SCH 608 falls into a measurement gap or an idle time slot 610.

For FCCH tone detection in an inter RAT measurement, the FCCH may fully or partially fall within the idle time slots of the first RAT (not shown). The UE attempts to detect FCCH tones (for example, such as the FCCH 606) on the BCCH carrier of the n strongest BCCH carriers of the cells in the second RAT. The strongest cells in the second RAT may be indicated by a measurement control message. In one configuration, n is eight and the n BCCH carriers are ranked in order of the signal strength. For example, a BCCH carrier may be ranked higher than other BCCH carriers when the signal strength of the BCCH carrier is stronger than the signal strength of the other BCCH carriers. The top ranked BCCH carrier may be prioritized for FCCH tone detection.

Each BCCH carrier may be associated with a neighbor cell in the second RAT. In some instances, the UE receives a neighbor cell list including n ranked neighbor cells from a base station of the first RAT, for example, in a measurement control message. The neighbor cells in the neighbor cell list may be ranked according to signal strength. In some configurations, the n ranked neighbor cells may correspond to the n strongest BCCH carriers, such that system acquisition of the neighbor cells includes FCCH tone detection of these BCCH carriers.

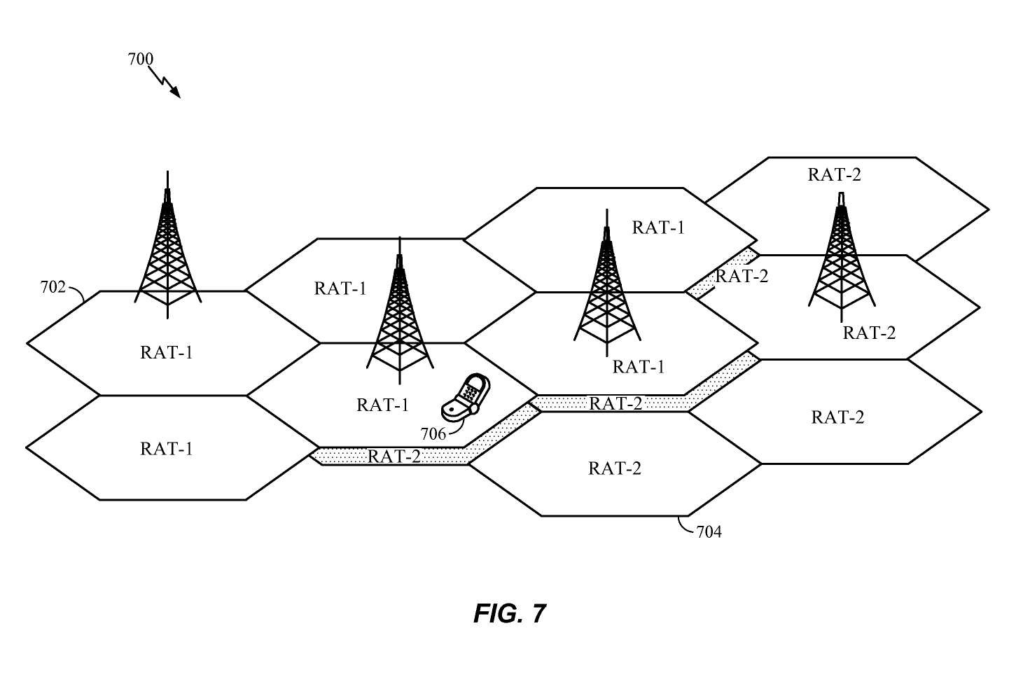

Some networks may be deployed with multiple radio access technologies. FIG. 7 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 700 includes RAT-1 cells 702 and RAT-2 cells 704. In one example, the RAT-1 cells are 2G or 3G cells and the RAT-2 cells are LTE cells. However, those skilled in the art will appreciate that other types of radio access technologies may be utilized within the cells. A user equipment (UE) 706 may move from one cell, such as a RAT-1 cell 702, to another cell, such as a RAT-2 cell 704. The movement of the UE 706 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

Ongoing communication on the UE may be handed over from the first RAT to a second RAT based on measurements performed on the second RAT. For example, the UE may tune away to the second RAT to perform the measurements. The UE may handover communications according to a single radio voice call continuity (SRVCC) procedure. SRVCC is a solution aimed at providing continuous voice services on packet-switched networks (e.g., LTE networks). In the early phases of LTE deployment, when UEs running voice services move out of an LTE network, the voice services can continue in the legacy circuit-switched (CS) domain using SRVCC, ensuring voice service continuity. SRVCC is a method of inter radio access technology (IRAT) handover. SRVCC enables smooth session transfers from voice over internet protocol (VoIP) over the IP multimedia subsystem (IMS) on the LTE network to circuit-switched services in the universal terrestrial radio access network (UTRAN) or GSM enhanced date rates for GSM Evolution (EDGE) radio access network (GERAN).

LTE coverage is limited in availability. When a UE that is conducting a packet-switched voice call (e.g., voice over LTE (VoLTE) call) leaves LTE coverage or when LTE network is highly loaded, SRVCC may be used to maintain voice call continuity from a packet-switched (PS) call to a circuit-switched call during IRAT handover scenarios. SRVCC may also be used, for example, when a UE has a circuit-switched voice preference (e.g., circuit-switched fallback (CSFB)) and packet-switched voice preference is secondary if combined attach fails. The evolved packet core (EPC) may send an accept message for PS Attach in which case a VoIP/IMS capable UE initiates a packet-switched voice call.

A UE may perform an LTE serving cell measurement. When the LTE serving cell signal strength or quality is below a threshold (meaning the LTE signal may not be sufficient for an ongoing call), the UE may report an event 2A (change of the best frequency). In response to the measurement report, the LTE network may send radio resource control (RRC) reconfiguration messages indicating 2G/3G neighbor frequencies. The RRC reconfiguration message also indicates event B1 (neighbor cell becomes better than an absolute threshold) and/or B2 (a serving RAT becomes worse than a threshold and the inter RAT neighbor becomes better than another threshold). The LTE network may also allocate LTE measurement gaps. For example, the measurement gap for LTE is a 6 ms gap that occurs every 40 or 80 ms. The UE uses the measurement gap to perform 2G/3G measurements and LTE inter frequency measurements.

The measurement gap may be used for multiple IRAT measurements and inter frequency measurements. The inter frequency measurements may include measurements of frequencies of a same RAT (e.g., serving LTE). The IRAT measurements may include measurements of frequencies of a different RAT (e.g., non-serving RAT such as TD-SCDMA or GSM). In some implementations, the LTE inter frequency measurements and TD-SCDMA IRAT measurements have a higher measurement scheduling priority than GSM.

Handover in conventional systems may be achieved by performing IRAT measurements and/or inter frequency measurements. For example, the IRAT and/or inter frequency searches and/or measurements include LTE inter-frequency searches and measurements, 3G searches and measurements, GSM searches and measurements, etc. followed by base station identity code (BSIC) procedures. The measurements may be attempted in measurements gaps that are inadequate (e.g., short duration such as 6 ms gap) for completion of the measurement procedure. In one instance, BSIC procedures may not be accomplished because a base station identification information does not fall within the short duration measurement gap. The BSIC procedures include frequency correction channel (FCCH) tone detection and synchronization channel (SCH) decoding that are performed after signal quality measurements.

When the base station identification information falls outside of the short duration measurement gap, the UE may be unable to detect the base station identification information and may be unable to synchronize with a target cell. For example, using a conventional 6 ms gap for every predefined time period (e.g., 40 ms or 80 ms), the base station identification information (e.g., FCCH and/or SCH) may not occur within the short duration measurement gap. That is, the FCCH and/or SCH do not occur during a remaining 5 ms gap after a frequency tuning period of 1 ms. If the UE is unable to detect the base station identification information communications may be interrupted. Further, repeated failed attempts by the UE may waste the UE's power.

The unpredictable failure of the FCCH /SCH to occur within the short duration measurement gap causes a variation of the IRAT measurement latency (e.g., increasing IRAT measurement latency). The failure of the FCCH/SCH to occur within the measurement gap may be due to a relative time between a serving RAT (e.g., LTE) and a neighbor RAT (e.g., GSM). The relative time impacts a time duration for the FCCH/SCH to fall into the 5 ms useful measurement gap (1 ms for frequency tuning). For example, the allocated time resources (e.g., frame timing) for the serving RAT and the neighbor RAT may be misaligned or offset, which causes failure of the FCCH/SCH to occur within the measurement gap of the serving RAT.

Because the UE may not be aware of the cause of the failure to detect the FCCH tone, for example, the UE may continue to attempt to detect the FCCH tone until an abort timer expires, which may cause delays in or interruptions to UE communications. For example, the UE may not be aware that the failure to detect the FCCH tone of the strongest frequency with the highest RSSI is due to low signal to noise ratio or FCCH occurring outside the measurement gap. As a result, the UE waits for an abort timer (e.g., 5 ms) to expire and then moves to the next strongest frequency. Waiting for expiration of the abort timer unnecessarily increase the IRAT measurement latency. However, if the UE aborts the FCCH tone detection prematurely, the UE may miss a chance of the FCCH occurring during the measurement gap.

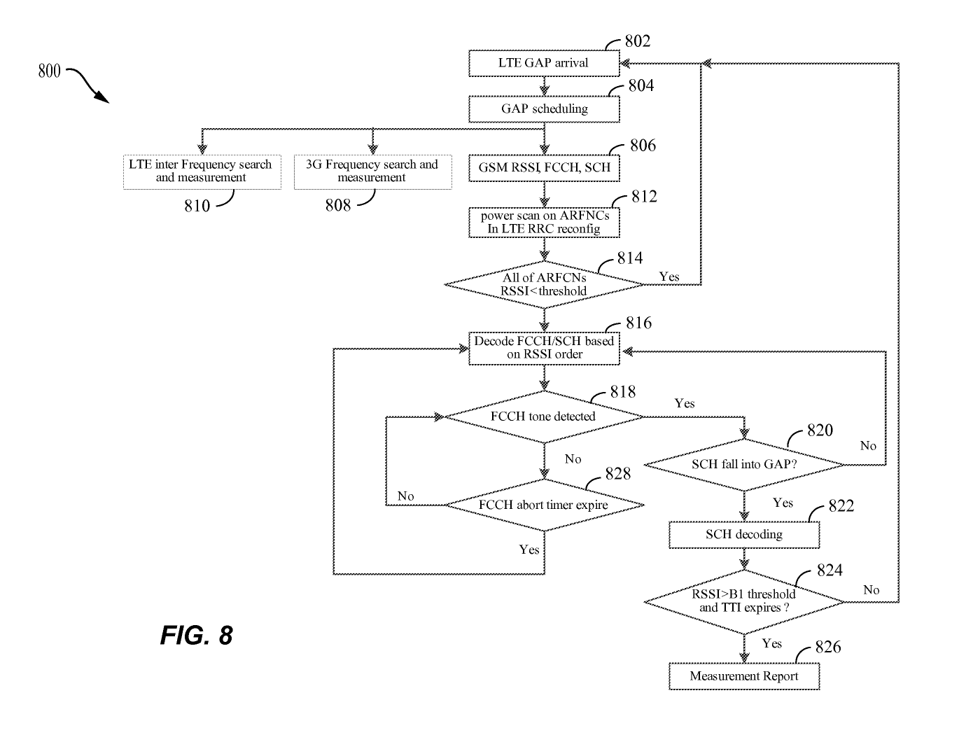

After the measurements, the UE may send a measurement report to the serving RAT. For example, the UE only sends the measurement report (e.g., B1 measurement report) after the completion of the BSIC procedures. Thus, the reporting of the results of the signal quality measurement, which occurs over a shorter period and which may occur on multiple occasions before the completion of the BSIC procedures, are delayed. Further, a transmission time interval (TTI) may expire prior to the completion of the BSIC procedures that result in an increase in latency or communication interruption. Measurement reports are transmitted to a network after the expiration of the TTI. Because the BSIC procedures are not complete, the measurement reports cannot be sent even when the TTI expires. An exemplary search and measurement procedure is illustrated in FIG. 8.

FIG. 8 is a flow diagram illustrating an example decision process for search and measurement of neighbor cells. The measurement may occur when the UE is on a first RAT (e.g., LTE) with a short duration measurement gap (e.g., 6 ms) every predefined period (e.g., 40 ms or 80 ms). The searches and measurements may include inter frequency searches and measurements and inter radio access technology (IRAT) searches and measurements. At block 802, measurement gap information transmitted by a network of the first RAT is received by the UE. For example, the measurement gap for LTE is a 6 ms gap that occurs every 40 or 80 ms. The UE uses the measurement gap to perform 2G/3G (e.g., TD-SCDMA and GSM) searches and measurements and LTE inter frequency searches and measurements. A search and/or measurement schedule for the neighbor cells may be received by the UE from the network, as shown in block 804. The searches and measurements of the neighbor cells may be scheduled based on priority. For example, searches and measurements of LTE/TD-SCDMA neighbor cells or frequencies may have a higher priority than GSM neighbor cells. At blocks 806, 808 and 810, the UE performs inter radio access technology (IRAT) and/or inter frequency searches and/or measurements. The IRAT and/or inter frequency searches and/or measurements include LTE inter-frequency searches and measurements, 3G searches and measurements, GSM searches, measurements and BSIC procedures, respectively, according to the schedule.

The user equipment performs measurements by scanning frequencies (e.g., power scan), as shown in block 812. The UE then determines whether a signal quality of a serving cell of a first RAT and the signal quality of neighbor cells meet a threshold, as shown in block 814. For example, it is determined whether the signal qualities (e.g., RSSIs) of the neighbor cells are less than the threshold. The threshold can be indicated to the UE through dedicated radio resource control (RRC) (e.g., LTE RRC reconfiguration) signaling from the network. When the signal quality of the neighbor cells fails to meet a threshold the process returns to block 802, in which the UE receives a next measurement gap information. However, when the signal qualities of one or more target neighbor cells meet the threshold, the UE continues to perform the BSIC procedures, as shown in block 816. The BSIC procedures may be performed on the target neighbor cells in order of signal quality. For example, the BSIC procedures may be performed on the cell with the best signal quality, followed by the cell with the second best signal quality and so on. The BSIC procedures include frequency correction channel (FCCH) tone detection and synchronization channel (SCH) decoding) that are performed after signal quality measurements.

In block 818, the UE may determine whether an FCCH tone is detected for a cell of the target cells (e.g., cell with best signal quality). If the FCCH tone is detected for the best cell, the UE determines whether the SCH falls into the measurement gap, as shown in block 820. In block 820, if the SCH does not fall into the measurement gap, the process returns to block 816, where the UE decodes FCCH/SCH for the target cell with the second best signal quality. However, if the SCH of the target neighbor cell with the best signal quality falls into the measurement gap, the UE performs SCH decoding, as shown in block 822. The UE then determines whether the signal quality of the target neighbor cell is greater than the threshold (e.g., B1 threshold) and whether the TTI has expired, as shown in block 824. If the TTI expired and the signal quality of the target neighbor cell is not greater than the threshold, the process returns to block 802, where the UE receives the measurement gap information. However, if the TTI expired and the signal quality of the target neighbor cell is greater than the threshold, the process continues to block 826, where the UE sends a measurement report to the network. As noted, measurement reports are transmitted to a network only after the expiration of the TTI, even when the other conditions, such as ab RSSI being greater than the threshold are met.

When it is determined that the FCCH tone for the target neighbor cell is not detected at block 818, the process continues to block 828, where it is determined whether the FCCH abort timer expired. If the FCCH abort time is not expired, the process returns to block 818, where the UE continues to determine whether an FCCH tone is detected for the target neighbor cell. Otherwise, when it is determined that the FCCH abort timer expired at block 828, the process returns to block 816 where FCCH/SCH is decoded for the next target neighbor cell.

The BSIC procedures, which include frequency correction channel (FCCH) tone detection and synchronization channel (SCH) decoding) that are performed after signal quality measurements, may further cause a drain in the UE battery power. For example, the UE may repeatedly attempt to detect an FCCH tone or to decode SCH when the SCH/FCCH does not fall in an allocated measurement gap. The repeated attempts further drain the UE battery power.

Power savings is especially important to ensure improved battery life for packet-switched devices (e.g., VoLTE devices) where voice calls (voice over internet protocol calls) can be frequent and long. During the voice over internet protocol calls, voice packet arrivals may exhibit traffic characteristics that are discontinuous. A discontinuous reception (DRX) mechanism may be implemented to reduce power consumption based on the discontinuous traffic characteristics of the voice packet arrivals.

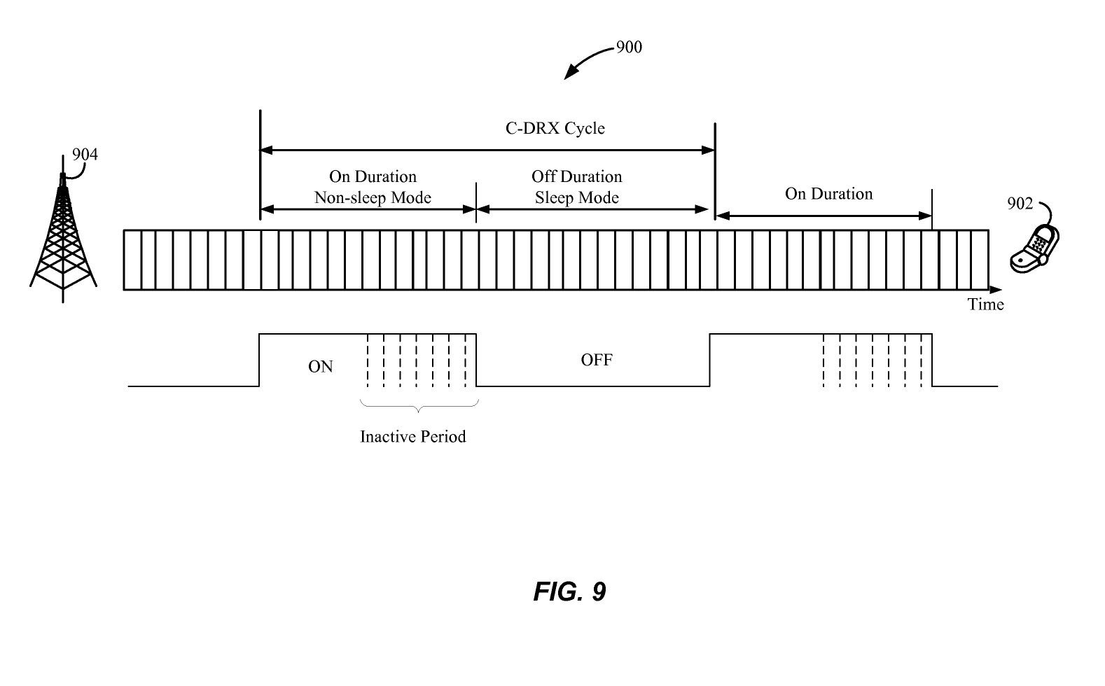

An exemplary discontinuous reception communication cycle 900 is illustrated in FIG. 9. The discontinuous reception cycle may correspond to a communication cycle where a user equipment (UE) 902 is in a connected mode (e.g., connected mode discontinuous reception (C-DRX) cycle). In the C-DRX cycle, the UE 902 may have an ongoing communication (e.g., voice call). For example, the ongoing communication may be discontinuous because of the inherent discontinuity in voice communications. The discontinuous communication cycle may also apply to other calls (e.g., multimedia calls).

The C-DRX cycle includes a time period/duration (e.g., C-DRX off duration) allocated for the UE 902 to sleep (e.g., sleep mode). In the sleep mode, the UE 902 may power down some of its components (e.g., receiver or receive chain is shut down). For example, when the UE 902 is in the connected state (e.g., RRC connected state) and communicating according to the C-DRX cycle, power consumption may be reduced by shutting down a receiver of the UE 902 for short periods. The C-DRX cycle also includes time periods when the UE 902 is awake (e.g., a non-sleep mode). The non-sleep mode may correspond to a time period (e.g., C-DRX on duration) allocated for the UE to stay awake. The C-DRX on duration includes a C-DRX on period and/or a C-DRX inactive period. The C-DRX on period corresponds to periods of communication (e.g., when the user is talking). The C-DRX inactive period, however, occurs during a pause in the communication (e.g., pauses in the conversation) that occurs prior to the C-DRX off duration.

The UE 902 enters the sleep mode to conserve energy when the pause in the communication extends beyond a duration of an inactivity timer. The inactivity timer may be configured by a network. The duration of the C-DRX inactive period is defined by the inactivity timer (e.g., C-DRX inactivity timer). For example, the UE 902 enters the sleep mode when the inactivity timer initiated at a start of the pause, expires. In some implementations, a duration of the inactivity timer and corresponding C-DRX inactive period, the C-DRX on period and the C-DRX off duration may be defined by the network. For example, the total DRX cycle may be 40 ms (e.g., one subframe corresponds to 1 ms). The C-DRX on period may have a duration of 4 subframes, the C-DRX inactive period may have a duration of 10 subframes and the C-DRX off duration may have a duration of 26 subframes.

During the time period allocated for the non-sleep mode, such as the C-DRX inactive period, the UE 902 monitors for downlink information such as a grant. For example, the downlink information may include a physical downlink control channel (PDCCH) of each subframe. The PDCCH may carry information to allocate resources for UEs 902 and control information for downlink channels. During the sleep mode, however, the UE 902 skips monitoring the PDCCH to save battery power. To achieve the power savings, the serving base station (e.g., eNodeB) 904, which is aware of the sleep and non-sleep modes of the communication cycle, skips scheduling downlink transmissions during the sleep mode. Thus, the UE 902 does not receive downlink information during the sleep mode and can therefore skip monitoring for downlink information to save battery power.

For example, when the UE is in the connected state and a time between the arrival of voice packets is longer than the inactivity timer (e.g., inactivity timer expires between voice activity) the UE transitions into the sleep mode. A start of the inactivity timer may coincide with a start of the C-DRX inactive period of an ongoing communication. The end of the inactivity timer may coincide with a start of the sleep mode or an end to the non-sleep mode provided there is no intervening reception of data prior to the expiration of the inactivity timer. When there is an intervening reception of data, the inactivity timer is reset.

In some implementations, the UE is awake during the time period (e.g., C-DRX off duration) allocated for the sleep mode. For example, during the C-DRX off duration, the UE performs activities or measurement procedures such as signal quality (e.g., RSSI) measurements and/or BSIC procedures (e.g., timing (FCCH/SCH) detection/decoding) instead of falling asleep. The UE first performs the signal quality measurements (e.g., IRAT measurements) by scanning frequencies (e.g., power scan) for a list of neighbor frequencies (e.g., GSM frequencies) indicated in a radio resource control (RRC) reconfiguration message, such as LTE RRC reconfiguration message. The UE then performs the BSIC procedures (e g , timing detection such as FCCH tone detection and SCH decoding) based on a ranked order of the frequencies. For example, the frequencies may be ranked according to their measured signal quality. The signal quality measurements and the BSIC procedures may be performed until the C-DRX off duration ends. In some implementations, however, the C-DRX off duration is insufficient for the measurement procedures. For example, the C-DRX off duration may be too short to complete FCCH tone detection and/or SCH decoding, which may repeat periodically (e.g., every 10 to 11 frames).

### User Equipment Based Connected Discontinuous Reception Inter Radio Access Technology Measurement

Aspects of the present disclosure are directed to improving measurement procedures, such as signal quality measurements and base station identity code (BSIC) procedures. The signal quality measurements may include inter radio access technology (IRAT) measurements of a non-serving RAT and/or inter frequency measurements of a serving RAT during a communication cycle (e.g., a connected discontinuous reception cycle (C-DRX)).

In one aspect of the disclosure, a user equipment (UE) determines whether to adjust a time period (e.g., C-DRX off duration) allocated for a sleep mode to perform activities or measurement procedures during the C-DRX off duration. The determination to adjust the C-DRX off duration (e.g., of one or more component carriers) may be based on whether certain communications conditions are satisfied. For example, the determination may be based on signal quality measurements (current and/or previous) of the serving RAT. The signal quality measurements may be performed during the time period allocated for the sleep mode. For example, signal qualities of frequencies of each of the serving cell and the neighbor cell(s) of the serving RAT may be compared against a threshold to determine whether each of the signal qualities is above or below the threshold. The threshold may be independently defined by the UE.

When the UE determines the serving cell and neighbor cells of the serving RAT are weak (e.g., each signal quality of the serving and one or more neighbor cells is below the threshold), a transition (e.g., handover or reselection) to a non-serving RAT becomes desirable. To achieve the transition, the UE performs measurements of the non-serving RAT. One way to expedite the transition is to adjust the C-DRX off duration to ensure that measurement procedures for the non-serving RAT are completed during the adjusted C-DRX off duration. For example, the UE adjusts the C-DRX off duration by extending the C-DRX off duration.

To extend the C-DRX off duration, the UE remains in the C-DRX off duration to continue to perform measurement procedures of the non-serving RAT, after a scheduled end of the C-DRX off duration (including a network configured end). The scheduled end of the C-DRX off duration may be configured by a network. The UE remains in the C-DRX mode to extend the time for performing the measurement procedures for the non-serving RAT. For example, the UE remains in the C-DRX off duration longer than the scheduled end of the sleep mode when consecutive measurement gaps for the IRAT measurements are longer than a current C-DRX off duration.

In another aspect of the present disclosure, the UE adjusts the C-DRX off duration based on a time difference between the scheduled end of the C-DRX off duration and a start of a measurement gap configured by the network. Further, the UE adjusts the C-DRX off duration based on a number of non-serving RAT frequencies or cells. In another aspect, the adjusting is based on a length of the C-DRX off duration and an expected length of time to complete the measurements for the non-serving RAT.

The UE may also extend the C-DRX off duration by entering the C-DRX off duration earlier than expected to expedite the transition. For example, the UE may enter the C-DRX off duration prior to expiration of the inactivity timer, which corresponds to a start of the C-DRX off duration. In other words, the UE enters the C-DRX off period during a time allocated for the inactive period of the C-DRX cycle.

In some aspects, the UE monitors for a grant channel for a portion of the inactivity time. When no grant is received during the portion of the inactivity time, the UE enters the C-DRX off duration prior to the expiration of the inactivity timer configured by the network. By entering the C-DRX off duration prior to a scheduled beginning of the C-DRX off duration, the measurements can be started earlier and the duration of the C-DRX off duration is also increased. Thus, the measurement period is also increased.

Upon completion of the measurements of the non-serving RAT, the UE sends a scheduling request and monitors for an uplink grant for sending a measurement report to the serving RAT. The UE then sends a measurement report using a received uplink grant. In one aspect of the disclosure, the UE adjusts the C-DRX off duration to ensure that the measurement report for the non-serving RAT is sent during the adjusted C-DRX off duration. This may include, for example, the UE waking up earlier than a network configured wake-up time to expedite the sending of the measurement report when the measurement procedures are completed before the end of the C-DRX off duration. In this case, the UE wakes up earlier than the network configured wake-up time even when there are no data in the UE buffer. Thus, rather than sleeping for the remainder of the C-DRX off duration, the UE wakes up earlier to send the measurement report prior to the end of the C-DRX off duration.

In another aspect of the disclosure, adjusting the C-DRX off duration is based on a purpose of the measurement procedure. For example, the UE does not extend the C-DRX off duration (e.g., enter the C-DRX off duration earlier and/or remain in the C-DRX off duration later) when the measurement procedure is a signal strength measurement. The UE may extend the C-DRX off duration when the measurement procedure is synchronization channel decoding or system information block (SIB) decoding.

In yet another aspect of the disclosure, adjusting the C-DRX off duration is based on a remaining battery life of the UE. For example, the UE does not extend the C-DRX off duration for the measurement procedure if the remaining battery life of the UE is low.

In a further aspect of the disclosure, adjusting the C-DRX off duration is based on a duration of the C-DRX cycle and/or the corresponding C-DRX off duration. For example, the C-DRX off duration is not extended when the time period allocated for the C-DRX cycle and/or the corresponding C-DRX off duration is long (e.g., greater than a threshold). Otherwise, the C-DRX off duration is extended when the time period allocated for the C-DRX cycle and/or the corresponding C-DRX off duration is short (e.g., less than a threshold). In some implementations, the time period allocated for the C-DRX cycle and corresponding C-DRX off duration, C-DRX on duration and/or C-DRX inactive period may be defined by a network. For example, the total C-DRX cycle may be 40 ms, 80 ms or 120 ms. The C-DRX on period may have a duration of 4 subframes, the C-DRX inactive period may have a duration of 10 subframes and the C-DRX off period may have a duration of 26 subframes.

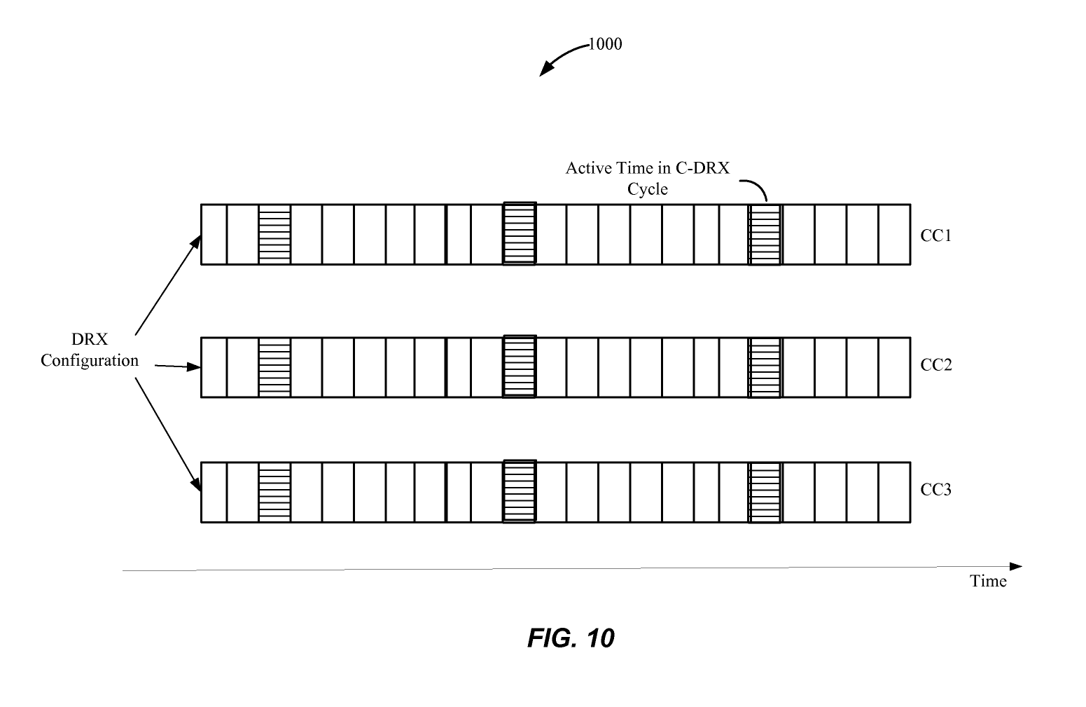

In some implementations, the UE may be configured to communicate according to a carrier aggregation (CA) configuration. For example, a carrier aggregation UE may be configured to communicate with the serving cell using multiple receivers. UEs, such as LTE-Advanced UEs, use spectrum in 20 MHz bandwidths allocated in a carrier aggregation of up to a total of 100 MHz (5 component carriers) used for transmission in each direction. Generally, less traffic is transmitted on the uplink than the downlink, so the uplink spectrum allocation may be smaller than the downlink allocation. For example, if 20 MHz is assigned to the uplink, the downlink may be assigned 100 MHz. These asymmetric FDD assignments will conserve spectrum and are a good fit for the typically asymmetric bandwidth utilization by broadband subscribers. Exemplary component carriers allocated for carrier aggregation are illustrated in FIG. 10.

FIG. 10 illustrates exemplary component carriers 1000 configured for carrier aggregation during a discontinuous reception (DRX) cycle (e.g., connected mode DRX cycle (C-DRX)). The component carriers include a first component carrier CC1, a second component carrier CC2 and a third component carrier CC3 at different time periods along a time axis. The component carriers CC1, CC2 and CC3 may be configured to operate during the C-DRX cycle in accordance with a DRX configuration. Conventionally, each of the component carriers CC1, CC2 and CC3 have identical C-DRX off duration and/or C-DRX on duration. For example, each of the component carriers CC1, CC2 and CC3 may be active at identical time periods in the C-DRX cycle.

In some aspects of the disclosure, a UE may determine whether to adjust a C-DRX off duration of one or more of the component carriers CC1, CC2 and CC3 when the UE is communicating with serving cells in accordance with a carrier aggregation configuration. The determination may be based on whether certain communications conditions, discussed herein, are satisfied. For example, the UE may adjust the C-DRX off duration of all of the component carriers (e.g., CC1, CC2 and CC3). In another aspect, the UE adjusts the C-DRX off duration of some of the component carriers (e.g., CC1) while the C-DRX off duration of the remaining component carriers (e.g., CC2 and CC3) remain unadjusted. Additionally, the UE may extend the C-DRX off duration of one component carriers (e.g., CC1) having degraded channel quality and/or a reported low multiple input multiple output (MIMO) rank. Alternatively, the UE may reduce the C-DRX off duration of other component carriers (e.g., CC2) when the component carrier has good channel quality and/or a reported high MIMO rank.

In yet another aspect of the disclosure, the carrier aggregation UE determines whether to adjust a C-DRX off duration of one or more of the component carriers CC1, CC2 and CC3 based on a type of the one or more component carriers of a current C-DRX cycle. The carrier aggregation UE also determines whether to adjust a C-DRX off duration of one or more of the component carriers CC1, CC2 and CC3 based on channel quality of the one or more component carriers and a difference between the types of component carriers. Additionally, aspects of the present disclosure reduce delays associated with IRAT measurements and reduce call drop.

FIG. 11 is a flow diagram illustrating a method 1100 for performing measurements during a discontinuous reception cycle according to one aspect of the present disclosure. At block 1102, a user equipment (UE) determines signal qualities of a serving cell and neighbor cells of a serving RAT. At block 1104, the UE adjusts a C-DRX off duration to perform measurements of a non-serving RAT during the C-DRX off duration based on the determined signal qualities of the serving RAT.

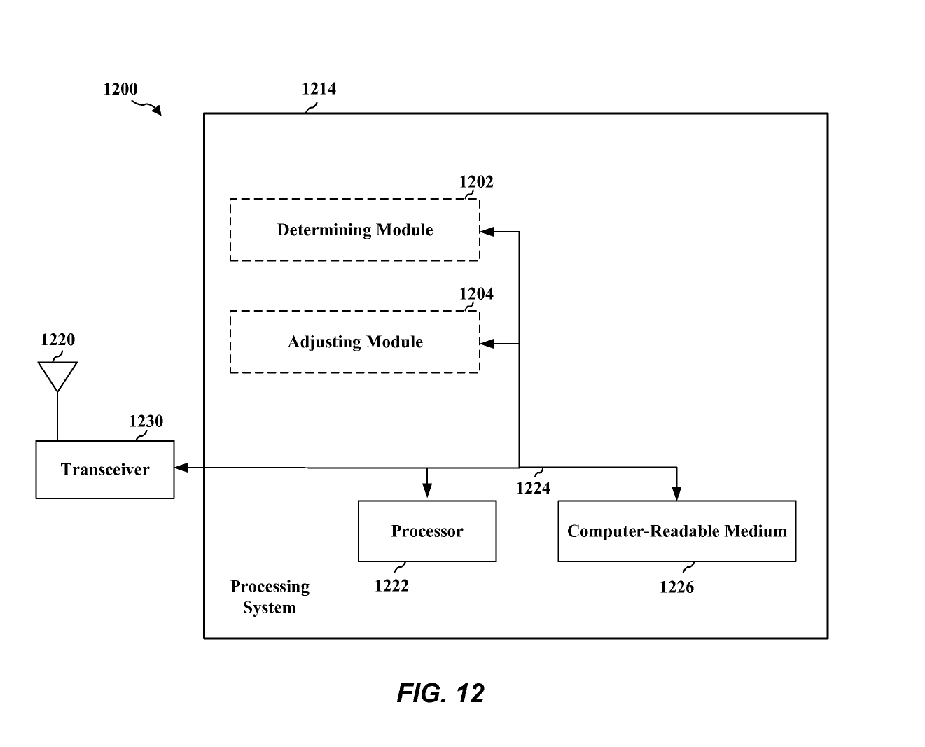

FIG. 12 is a diagram illustrating an example of a hardware implementation for an apparatus 1200 employing a processing system 1214 according to one aspect of the present disclosure. The processing system 1214 may be implemented with a bus architecture, represented generally by the bus 1224. The bus 1224 may include any number of interconnecting buses and bridges depending on the specific application of the processing system 1214 and the overall design constraints. The bus 1224 links together various circuits including one or more processors and/or hardware modules, represented by the processor 1222, the determining module 1202, the adjusting module 1204 and the non-transitory computer-readable medium 1226. The bus 1224 may also link various other circuits such as timing sources, peripherals, voltage regulators, and power management circuits, which are well known in the art, and therefore, will not be described any further.

The apparatus includes a processing system 1214 coupled to a transceiver 1230. The transceiver 1230 is coupled to one or more antennas 1220. The transceiver 1230 enables communicating with various other apparatus over a transmission medium. The processing system 1214 includes a processor 1222 coupled to a non-transitory computer-readable medium 1226. The processor 1222 is responsible for general processing, including the execution of software stored on the computer-readable medium 1226. The software, when executed by the processor 1222, causes the processing system 1214 to perform the various functions described for any particular apparatus. The computer-readable medium 1226 may also be used for storing data that is manipulated by the processor 1222 when executing software.

The processing system 1214 includes a determining module 1202 for determining signal qualities of a serving cell and neighbor cells of a serving RAT. The processing system also includes an adjusting module 1204 for adjusting a C-DRX off duration to perform measurements of a non-serving RAT during the C-DRX off mode based on the determined signal qualities of the serving RAT. The determining module 1202 may be software module(s) running in the processor 1222, resident/stored in the computer-readable medium 1226, one or more hardware modules coupled to the processor 1222, or some combination thereof The processing system 1214 may be a component of the UE 550 of FIG. 5 and may include the memory 582, and/or the controller/processor 580.

In one configuration, an apparatus such as a UE 550 is configured for wireless communication including means for determining In one aspect, the determining means may be the receive processor 558, the controller/processor 580, the memory 582, the wireless communication module 591, the determining module 1202, and/or the processing system 1214 configured to perform the aforementioned means. In one configuration, the means functions correspond to the aforementioned structures. In another aspect, the aforementioned means may be a module or any apparatus configured to perform the functions recited by the aforementioned means.

In one configuration, an apparatus such as a UE 550 is configured for wireless communication including means for adjusting. In one aspect, the adjusting means may be the receive processor 558, the controller/processor 580, the memory 582, the wireless communication module 591, the adjusting module 1204, and/or the processing system 1214 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE, TD-SCDMA and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a UE (user equipment), comprising:
determining signal qualities of a serving cell and neighbor cells of a serving RAT (radio access technology); and
adjusting a C-DRX off duration (connected discontinuous reception off duration) on a component carrier to perform measurements of a non-serving RAT during the C-DRX off duration based at least in part on the determined signal qualities of the serving RAT.

2. The method of claim 1, in which the adjusting further comprises remaining in the C-DRX off duration to continue performing the measurements of the non-serving RAT, after a network configured end of the C-DRX off duration.

3. The method of claim 1, in which the adjusting further comprises entering the C-DRX off duration to perform the measurements prior to expiration of a C-DRX inactivity timer configured by a network.

4. The method of claim 1, further comprising monitoring for a grant channel for a portion of a C-DRX inactivity timer and entering a C-DRX off duration earlier than a network configured time when no grant is received during the portion of the C-DRX inactivity timer.

5. The method of claim 1, in which the adjusting further comprises waking up earlier than a network configured wake-up time to send a measurement report when the measurements are completed before an end of the C-DRX off duration even when no data is in a UE buffer.

6. The method of claim 1, in which adjusting is based at least in part on a purpose of the measurements of the non-serving RAT.

7. The method of claim 1, further comprising preventing extending of the C-DRX off duration for the measurements of the non-serving RAT when a UE battery is low.

8. The method of claim 1, in which adjusting is based at least in part on a length of the C-DRX off duration and an expected length of time to complete the measurements for the non-serving RAT.

9. The method of claim 1, in which the UE is configured to communicate with the serving cell using multiple receivers according to a carrier aggregation configuration (CA configuration) and in which the adjusting further comprises adjusting only the C-DRX off duration of some of the component carriers of the carrier aggregation configuration while the C-DRX off duration of other component carriers of the carrier aggregation configuration remain unadjusted.

10. The method of claim 9, further comprising adjusting the C-DRX off duration of the component carriers based at least in part on channel quality and/or reported multiple input multiple output (MIMO) rank of each of the component carriers.

11. The method of claim 9, in which the adjusting is based at least in part on a type of the component carriers of a current C-DRX cycle.

12. The method of claim 9, in which the adjusting is based at least in part on a channel quality of the component carriers and a difference between types of the component carriers.

13. The method of claim 1, in which the adjusting is based at least in part on a time difference between an end of the C-DRX off duration and a start of a measurement gap configured by a network.

14. The method of claim 1, in which the adjusting is based at least in part on a number of non-serving RAT frequencies or cells.

15. An apparatus for wireless communication in a UE (user equipment), comprising:
means for determining signal qualities of a serving cell and neighbor cells of a serving RAT (radio access technology); and
means for adjusting a C-DRX off duration (connected discontinuous reception off duration) on a component carrier to perform measurements of a non-serving RAT during the C-DRX off duration based at least in part on determined signal qualities of the serving RAT.

16. An apparatus for wireless communication in a UE (user equipment), comprising:
a memory;
a transceiver configured for wireless communication; and
at least one processor coupled to the memory and the transceiver, the at least one processor configured:
to determine signal qualities of a serving cell and neighbor cells of a serving RAT (radio access technology); and
to adjust a C-DRX off duration (connected discontinuous reception off duration) on a component carrier to perform measurements of a non-serving RAT during the C-DRX off duration based at least in part on determined signal qualities of the serving RAT.

17. The apparatus of claim 16, in which the at least one processor is further configured to adjust by remaining in the C-DRX off duration to continue performing the measurements of the non-serving RAT, after a network configured end of the C-DRX off duration.

18. The apparatus of claim 16, in which the at least one processor is further configured to adjust by entering the C-DRX off duration to perform the measurements prior to expiration of a C-DRX inactivity timer configured by a network.

19. The apparatus of claim 16, in which the at least one processor is further configured to monitor for a grant channel for a portion of a C-DRX inactivity timer and entering a C-DRX off duration earlier than a network configured time when no grant is received during the portion of the C-DRX inactivity timer.

20. The apparatus of claim 16, in which the at least one processor is further configured to cause the UE to waking up earlier than a network configured wake-up time to send a measurement report when the measurements are completed before an end of the C-DRX off duration even when no data is in a UE buffer.

21. The apparatus of claim 16, in which the at least one processor is further configured to adjust based at least in part on a purpose of the measurements of the non-serving RAT.

22. The apparatus of claim 16, in which the at least one processor is further configured to prevent extending of the C-DRX off duration for the measurements of the non-serving RAT when a UE battery is low.

23. The apparatus of claim 16, in which the at least one processor is further configured to adjust based at least in part on a length of the C-DRX off duration and an expected length of time to complete the measurements for the non-serving RAT.

24. The apparatus of claim 16, in which the UE is configured to communicate with the serving cell using multiple receivers according to a carrier aggregation configuration (CA configuration) and in which the at least one processor is further configured to adjust by adjusting only the C-DRX off duration of some of the component carriers of the carrier aggregation configuration while the C-DRX off duration of other component carriers of the carrier aggregation configuration remain unadjusted.

25. The apparatus of claim 24, in which the at least one processor is further configured to adjust the C-DRX off duration of the component carriers based at least in part on channel quality and/or reported multiple input multiple output (MIMO) rank of each of the component carriers.

26. The apparatus of claim 24, in which the at least one processor is further configured to adjust based at least in part on a type of the component carriers of a current C-DRX cycle.

27. The apparatus of claim 24, in which the at least one processor is further configured to adjust based at least in part on channel quality of the component carriers and a difference between types of the component carriers.

28. The apparatus of claim 16, in which the at least one processor is further configured to adjust based at least in part on a time difference between an end of the C-DRX off duration and a start of a measurement gap configured by a network.

29. The apparatus of claim 16, in which the at least one processor is further configured to adjust based at least in part on a number of non-serving RAT frequencies or cells.

30. A non-transitory computer-readable medium having program code recorded thereon, the program code comprising:
program code to determine signal qualities of a serving cell and neighbor cells of a serving RAT (radio access technology); and
program code to adjust a C-DRX off duration (connected discontinuous reception off duration) on a component carrier to perform measurements of a non-serving RAT during the C-DRX off duration based at least in part on determined signal qualities of the serving RAT.
